(19) United States
(12) Patent Application Publication
(10) Pub. No.: US 2004/0062540 A1
(43) Pub. Date: Apr. 1, 2004

(54) Method and system for driving an SLR camera

(75) Inventor: Masayuki Misawa, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/602,632

(22) Filed: Jun. 25, 2003

(30) Foreign Application Priority Data
Jun. 28, 2002 (JP) 2002-189797

(51) Int. Cl. G03B 1/00

(52) U.S. Cl. 396/387

(57) ABSTRACT

A method of driving an SLR camera using a single motor includes driving the motor forward to perform a mirror release operation, driving the motor in reverse to switch a motor drive system including the motor to a mirror-shutter charge system and performing a mirror-shutter charge operation, driving the motor to continue rotating in reverse to switch the motor drive system a film wind system, driving the motor to continue rotating in reverse to perform a film wind operation, driving the motor forward for a predetermined period of time to switch the motor drive system from the film wind system to a film rewind system upon detecting that there are no more film frames available, and driving the motor in reverse to perform the film rewind operation.

### BACKGROUND OF THE INVENTION

1. Field of the Invention

The present invention relates to a method and system for driving an SLR camera.

2. Description of the Related Art

SLR cameras using a single motor to perform multiple driving operations, e.g., a film wind operation, a film rewind operation, a mirror-shutter charge operation, and a mirror release operation in which a quick-return mirror rises upon a shutter release, are known in the art.

### SUMMARY OF THE INVENTION

The present invention provides a method and system for driving an SLR camera that uses a single motor to perform such multiple driving operations in a control mode different from any control modes of conventional SLR cameras that use a single motor to perform similar multiple driving operations.

According to an aspect of the present invention, a method of driving an SLR camera, having a film, is provided, using a single motor to perform a film wind operation, a film rewind operation, a mirror-shutter charge operation, and a mirror release operation in which a quick-return mirror rises upon a shutter release, the method including driving the motor forward to perform the mirror release operation upon a detection of the shutter release; driving the motor in reverse to firstly switch a motor drive system including the motor to a mirror-shutter charge system upon detecting a signal indicating that an operation of a shutter is completed, and subsequently performing the mirror-shutter charge operation; driving the motor to continue rotating in reverse to switch the motor drive system from the mirror-shutter charge system to a film wind system even after the quick-return mirror returns to a viewing position by the mirror-shutter charge operation; driving the motor to continue rotating in reverse to perform the film wind operation; driving the motor forward for a predetermined period of time to switch the motor drive system from the film wind system to a film rewind system upon detecting a signal indicating that no more frames of the film are available; and driving the motor in reverse to perform the film rewind operation.

It is desirable for the method to further include putting the motor drive system into a state where the motor drive system is prevented from switching to the mirror-shutter charge system when the film wind operation and film rewind operation are performed; and putting the motor drive system into a state where the motor drive system is allowed to switch to the mirror-shutter charge system in conjunction with a rising motion of the quick-return mirror upon the mirror release operation.

In another embodiment, a driving system for an SLR camera, having a film, is provided, using a single motor to perform a film wind operation, a film rewind operation, a mirror-shutter charge operation, and a mirror release operation in which a quick-return mirror rises upon a shutter release, the driving system including a release device which drives the motor forward to perform the mirror release operation upon a detection of the shutter release; a switch/charge device which is actuated upon the motor being driven in reverse to firstly switch a motor drive system including the motor to a mirror-shutter charge system upon detecting a signal indicating that an operation of a shutter is completed, and subsequently perform the mirror-shutter charge operation; a first switch device which drives the motor to continue rotating reverse to switch the motor drive system from the mirror-shutter charge system to a film wind system even after the quick-return mirror returns to a viewing position by the mirror-shutter charge operation; a film wind device which drives the motor to continue rotating reverse to perform the film wind operation; a second switch device which drives the motor forward for a predetermined period of time to switch the motor drive system from the film wind system to a film rewind system upon detecting a signal indicating that no more film frame is available; and a film rewind device which drives the motor reverse to perform the film rewind operation.

It is desirable for the driving system to further include a locking device which puts the motor drive system into a state where the motor drive system is prevented from switching to the mirror-shutter charge system when the film wind operation and film rewind operation are performed; and an unlocking device which puts the motor drive system into a state where the motor drive system is allowed to switch to the mirror-shutter charge system in conjunction with a rising motion of the quick-return mirror upon the mirror release operation.

In another embodiment, an SLR camera is provided, using a single motor to perform a film wind operation, a film rewind operation, a mirror-shutter charge operation, and a mirror release operation in which a quick-return mirror rises upon a shutter release, the SLR camera including a film-wind gear mechanism used for the film wind operation; a film-rewind gear mechanism used for the film rewind operation; a mirror-shutter charge gear mechanism used for the mirror release operation; a mirror release gear mechanism used for the mirror release operation; a motor drive gear mechanism which is selectively engaged with the film wind gear mechanism, the film rewind gear mechanism, the mirror-shutter charge gear mechanism and the mirror release gear mechanism; and a motor controller for controlling operation of the motor. The motor controller drives the motor forward to bring the motor drive gear mechanism into engagement with the mirror release gear mechanism to perform the mirror release operation upon a detection of the shutter release, a rising motion of the quick-return mirror making it possible to bring the motor drive gear mechanism into engagement with the mirror-shutter charge gear mechanism. The motor controller drives the motor in reverse to firstly bring the motor drive gear mechanism into engagement with the mirror-shutter charge gear mechanism upon detecting a signal indicating that an operation of a shutter is completed, and subsequently perform the mirror-shutter charge operation. The motor controller drives the motor to continue rotating in reverse to bring the motor drive gear mechanism into engagement with the film wind gear mechanism even after the quick-return mirror returns to a viewing position by the mirror-shutter charge operation. The motor controller drives the motor to continue rotating in reverse to perform the film wind operation. The motor controller drives the motor forward for a predetermined period of time to bring the motor drive gear mechanism into engagement with the film rewind gear mechanism upon detecting a signal indicating that no more film frame is available. The motor controller drives the motor reverse to perform the film rewind operation.

In another embodiment, a driving system for an SLR camera is provided, including a motor; a release mechanism which performs a mirror-shutter release operation in which a quick-return mirror is removed from a viewing position, on a photographing path, to raised position, out of the photographing path, and a mechanical stopper for a shutter is released; a charge mechanism which performs a mirror-shutter charge operation in which the quick-return mirror is returned to the viewing position and the shutter is charged; a film-wind mechanism which performs a film wind operation; a film rewind mechanism which performs a film rewind operation; and a switching device provided between the motor and the release mechanism, the charge mechanism, the film-wind mechanism, and the film rewind mechanism, wherein the mirror-shutter release operation is performed by the release mechanism when the motor drives forward; and wherein the mirror-shutter charge operation, the film wind operation and the film rewind operation are performed by the charge mechanism, the film wind mechanism and the film rewind mechanism, respectively, when the motor drives in reverse after the release operation is completed.

The present disclosure relates to subject matter contained in Japanese Patent Application No.2002-189797 (filed on Jun. 28, 2002) which is expressly incorporated herein by reference in its entirety.

### BRIEF DESCRIPTION OF THE DRAWINGS

The present invention will be described below in detail with reference to the accompanying drawings in which:

FIG. 1 is a system diagram of a fundamental portion of an embodiment of a driving system for driving an SLR camera in an initial state (i.e., in a state before a shutter release signal is issued), according to the present invention;

FIG. 2 is a system diagram of the embodiment of a fundamental portion of the SLR camera driving system in a state immediately after a mirror-shutter charge operation commences after a shutter release operation is completed;

FIG. 3 is a system diagram of the embodiment of a fundamental portion of the SLR camera driving system in a state where the mirror-shutter charge operation is almost completed;

FIG. 4 is a system diagram of the embodiment of a fundamental portion of the SLR camera driving system in a state where a motor drive system of the SLR camera driving system is in the process of being switched from a mirror-shutter charge system to a film wind system after the mirror-shutter charge operation is completed;

FIG. 5 is a system diagram of the embodiment of a fundamental portion of the SLR camera driving system in a state where a film wind operation by the film wind system is completed;

FIG. 6 is a system diagram of the embodiment of a fundamental portion of the SLR camera driving system in a state where a film rewind operation is performed;

FIG. 7A is a side elevational view of a mirror drive mechanism and peripheral components including components of the mirror-shutter charge system in a state where a quick-return mirror is in a viewing position (initial position);

FIG. 7B is a view similar to that of FIG. 7A, showing a state where the quick-return mirror is in a raised position (retracted position);

FIG. 8 is a first half of a timing chart showing fundamental operations of the SLR camera driving system; and

FIG. 9 is a latter half of the timing chart showing fundamental operations of the SLR camera driving system.

### DESCRIPTION OF THE PREFERRED EMBODIMENT

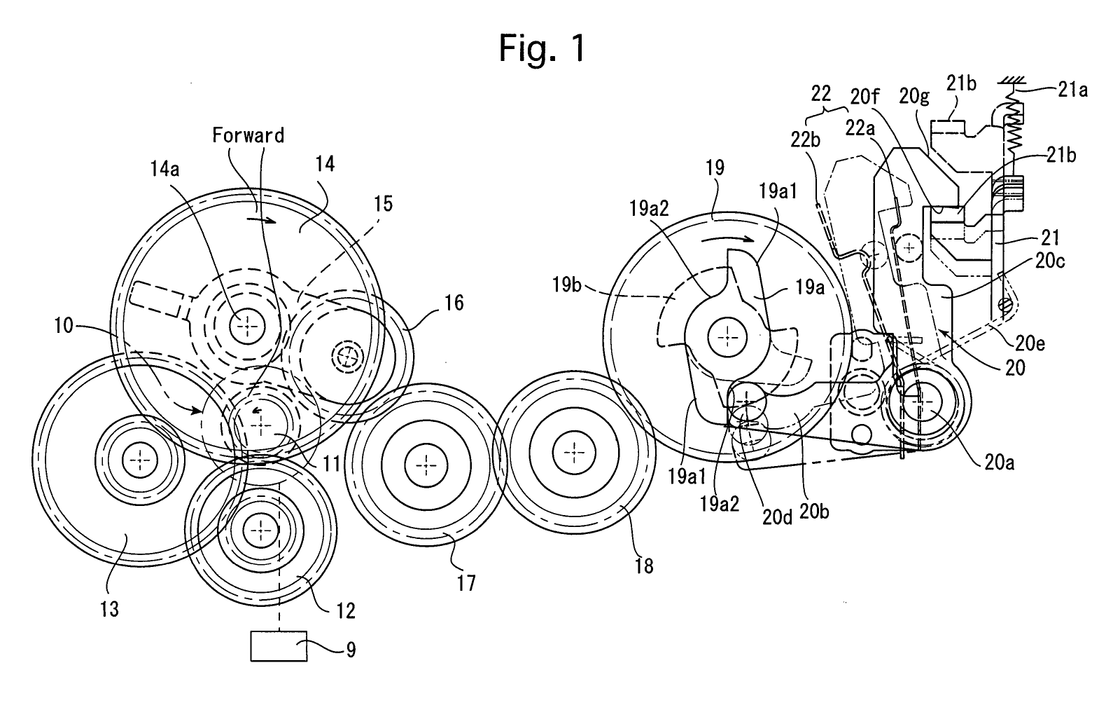

FIGS. 1 through 6 are system diagrams of an embodiment of a driving system for driving an SLR camera according to the present invention, showing different operating states thereof. In some of these figures, only elements of the SLR camera driving system which are associated with descriptions of the operations performed in the operational state are shown for the purpose of clarity.

FIG. 1 shows the SLR camera driving system in an initial state (i.e., in a state before a shutter release signal is issued after a mirror-shutter charge operation is completed). In this state, leading and trailing curtains of a focal plane shutter (not shown) are mechanically latched (held) at respective charge completion positions. The SLR camera driving system is provided with a motor 10 (see FIG. 1), a motor controller 9 which controls operation of the motor 10, and a drive pinion 11 which is fixed on a rotary shaft of the motor 10. The SLR camera driving system is provided in the vicinity of the drive pinion 11 with a first double gear 12, a second double gear 13 and a third double gear 14. The drive pinion 11 is in mesh with a large gear of the first double gear 12, a small gear of the first double gear 12 is in mesh with a large gear of the second double gear 13, and a small gear of the second double gear 13 is in mesh with a large gear of the third double gear 14. The SLR camera driving system is provided with a first planetary gear mechanism having the third double gear 14 serving as a sun gear, and a first planet gear 16 which is in mesh with a small gear of the third double gear 14. A first swingable lever 15 is pivoted at one end thereof about a rotational shaft 14a of the third double gear 14. The first planet gear 16 is rotatably fitted on a pin which is fixed at a free end of the first swingable lever 15 to extend parallel to the rotational shaft 14a. The first swingable lever 15 swings about the rotational shaft 14a in forward and reverse directions by rotation of the first planet gear 16 around the small gear of the third double gear 14. In a state shown in FIG. 1, the drive pinion 11 (motor 10) rotates in a forward direction, so that the first swingable lever 15 that bears the first planet gear 16 rotates clockwise as viewed in FIG. 1. The drive pinion 11, the first, second and third double gears 12, 13 and 14, the first swingable lever 15 and the first planet gear 16 constitute a motor-drive gear mechanism.

The SLR camera driving system is further provided with mirror-release gear mechanism (release mechanism) having a first idle gear 17, a second idle gear 18, a cam-incorporated gear 19, a release lever 20 and a mirror charge lever 21. When the first swingable lever 15 rotates clockwise as viewed in FIG. 1, the first planet gear 16 that is rotatably fixed at the free end of the first swingable lever 15 is in mesh with the first idle gear 17 which is in mesh with the second idle gear 18, and the cam-incorporated gear 19 is in mesh with the second idle gear 18. Namely, when the first swingable lever 15 rotates clockwise as viewed in FIG. 1, the planet gear 16 is engaged with the cam-incorporated gear 19 via the first and second idle gears 17 and 18. The cam-incorporated gear 19 is provided on front and rear sides thereof with a release cam 19a shown by solid line in FIG. 1 and a lock cam 19b shown by dotted lines in FIG. 1. The release cam 19a is symmetrical with respect to a rotational axis of the cam-incorporated gear 19. The release cam 19a is composed of a pair of pressure cam edges 19a1, the distances of which gradually increase in a counterclockwise direction from the rotational axis of the cam-incorporated gear 19 as viewed in FIG. 1, and a pair of cam edges 19a2, the distances of which suddenly decrease in a counterclockwise direction from the rotational axis of the cam-incorporated gear 19 as viewed in FIG. 1.

The release lever 20 is positioned in the vicinity of the cam-incorporated gear 19. The release lever 20 is pivoted about a rotational shaft 20a extending parallel to the rotational axis of the cam-incorporated gear 19. The release lever 20 is provided with a first arm portion 20b and a second arm portion 20c which extend substantially orthogonal to each other. The first arm portion 20b is provided at a tip thereof with a follower roller 20d which is engaged with the release cam 19a.

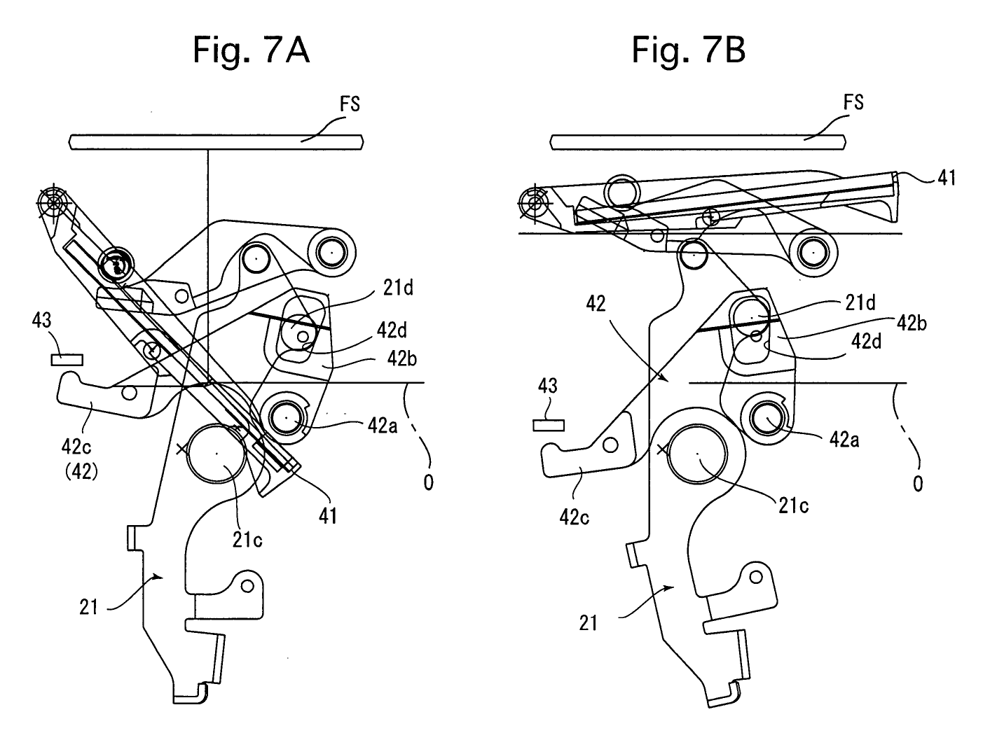

The second arm portion 20c of the release lever 20 is provided with a engaging recess 20f which is engageable with the mirror charge lever 21 to hold the mirror charge lever 21 in a lever holding position (shown by solid lines in FIG. 1), i.e., in a charge completion position. The mirror charge lever 21 is always interconnected with a quick-return mirror (hinged mirror) 41 (see FIGS. 7A and 7B), and is biased to rotate about a rotational shaft 21c in a direction to raise the quick-return mirror 41 to retract the quick-return mirror 41 from a photographing optical path behind a photographing lens, i.e. in a counterclockwise direction as viewed in FIGS. 7A and 7B, by the spring force of an extension spring 21a. The quick-return mirror 41 rises by the spring force of the extension spring 21a to be positioned in a retracted position (raised position) as shown in FIG. 7B when the mirror charge lever 21 is in a position (retracted position) shown by dotted lines in FIG. 1. The quick-return mirror 41 is held in a viewing position shown in FIG. 7A, in which the quick-return mirror 41 is angled relative to a photographing optical axis 0 by an angle of approximately 45 degrees, when the mirror charge lever 21 is in a position (lever holding position) shown by solid lines in FIG. 1 with the extension spring 21a being expanded. As shown in FIGS. 7A and 7B, a focusing screen FS serving as an element of a viewfinder optical system of the SLR camera is positioned above the quick-return mirror 41. When the quick-return mirror 41 is in the viewing position as shown in FIG. 7A, the light from the object which is passed through a photographing lens (not shown) of the SLR camera is reflected upwards by the quick-return mirror 41 to be incident on the focusing screen FS. The mirror charge lever 21 is provided with a stop arm portion 21b which is engageable with the engaging recess 20f of the release lever 20 to hold the mirror charge lever 21 in the lever holding position thereof.

As shown in FIGS. 7A and 7B, the SLR camera driving system is provided with a shutter charge lever 42 which is pivoted about a rotational shaft 42a extending parallel to the rotational shaft 21c of the mirror charge lever 21. The shutter charge lever 42 is provided with a first arm portion 42b and a second arm portion 42c. The shutter charge lever 42 is provided on the first arm portion 42b with a cam slot 42d while the mirror charge lever 21 is provided with a follower roller 21d which is engaged in the cam slot 42d so that the shutter charge lever 42 rotates about the rotational shaft 42a by rotation of the mirror charge lever 21 by engagement of the follower roller 21d with the cam slot 42d.

The release lever 20 is biased to rotate clockwise with respect to FIG. 1 by the spring force of a torsion spring (release lever resetting spring) 20e (see FIG. 1) so that the stop arm portion 21b is engaged with the engaging recess 20f and so that the follower roller 20d is engaged with the release cam 19a. The release lever 20 is provided with a bevel 20g which is engageable with the stop arm portion 21b of the mirror charge lever 21 when the mirror charge lever 21 rotates from a retracted position (shown by dotted lines in FIG. 1) to the lever holding position (shown by solid lines in FIG. 1). When the mirror charge lever 21 rotates from the retracted position to the lever holding position, a corresponding bevel of the stop arm portion 21b of the mirror charge lever 21 comes into contact with the bevel 20g and subsequently presses the bevel 20g so that the release lever 20 rotates counterclockwise as viewed in FIG. 1 against the spring force of the torsion spring 20e.

The SLR camera driving system is provided with a mirror-up switch 22 having a first leaf 22a and a second leaf 22b. The first leaf 22a is supported by the release lever 20 to be movable together with the release lever 20. The first leaf 22a comes into contact with the second leaf 22b to thereby detect that the quick-return mirror 41 is in the retracted position when the release lever 20 rotates counterclockwise, as viewed in FIG. 1, to disengage the stop arm portion 21b of the mirror charge lever 21 from the engaging recess 20f.

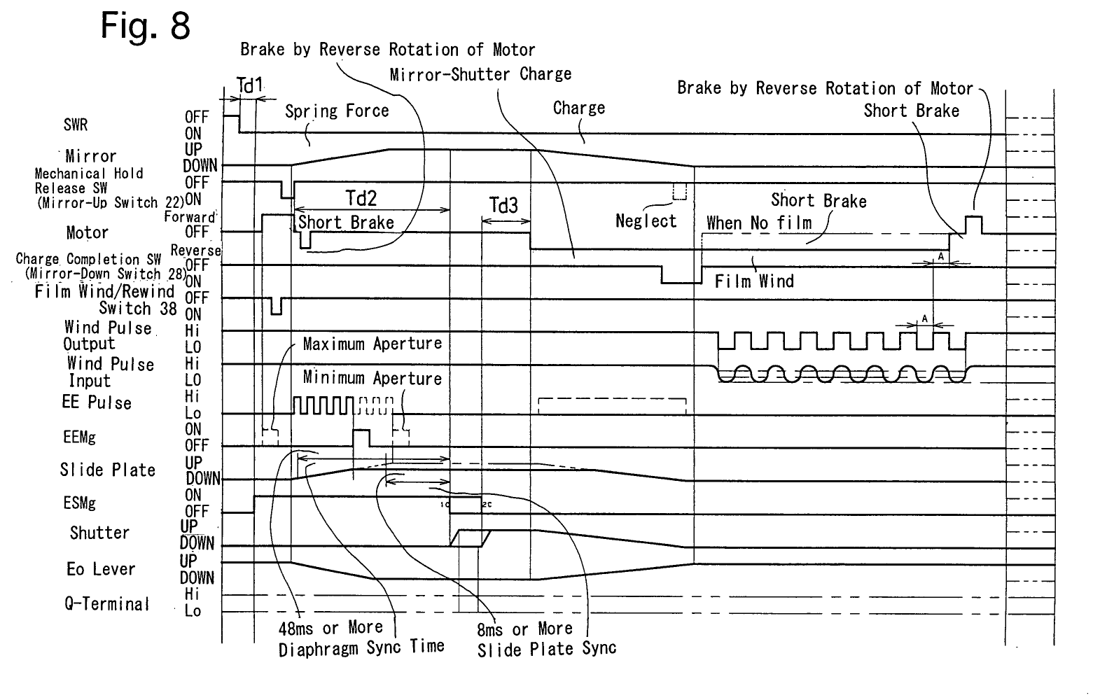

A mirror release operation in which the quick-return mirror 41 rises upon a shutter release will be hereinafter discussed. Upon the drive pinion 11 being rotated forward with a delay of a predetermined period of time after a shutter release signal (SWR shown in FIG. 8) is issued, the cam-incorporated gear 19 rotates clockwise as viewed in FIG. 1 by the forward rotation of the drive pinion 11 via the first and second idle gears 17 and 18 so that one of the pair of pressure cam edges 19a1 of the release cam 19a presses the follower roller 20d to rotate the release lever 20 counterclockwise as viewed in FIG. 1. The rotation of the release lever 20 in a counterclockwise direction causes the stop arm portion 21b to disengage from the engaging recess 20f so that the quick-return mirror 41 rises to retract from a photographing optical path by the spring force of the extension spring 21a. Immediately after a period of time Td1 elapses from the moment the shutter release signal SWR shown in FIG. 8 is issued, a leading-curtain holding magnet and a trailing-curtain holding magnet ESMg are energized to hold the leading and trailing curtains of the focal plane shutter in the respective charge completion positions. After the leading-curtain and trailing-curtain holding magnets ESMg are energized, the shutter charge lever 42 which mechanically holds the leading and trailing curtains of the focal plane shutter in the respective charge completion positions is retracted to a retracted position as shown in FIG. 7B to release the mechanical holding of the leading and trailing curtains of the focal plane shutter.

Immediately after the follower roller 20d moves from the currently-engaged one of the pair of pressure cam edges 19a1 to one of the pair of cam edges 19a2 while the motor 10 is rotating forward, the release lever 20 rapidly rotates clockwise as viewed in FIG. 1 by the spring force of the torsion spring 20e. This causes the first leaf 22a to be disengaged from the second leaf 22b to turn OFF the mirror-up switch 22. Immediately after a signal is issued upon this change of the mirror-up switch 22 from ON to OFF, the motor 10 is stopped (a braking operation of the motor 10 is performed). Immediately after a period of time Td2 elapses from the moment of the change of the mirror-up switch 22 from ON to OFF, the leading-curtain holding magnet (ESMg) is de-energized to cause the leading curtain to start moving to thereby start an exposure. Immediately after an exposure time calculated by an exposure control circuit (not shown) elapses from the commencement of the movement of the leading curtain, the trailing-curtain holding magnet (ESMg) is de-energized to cause the trailing curtain to start moving to complete the exposure.

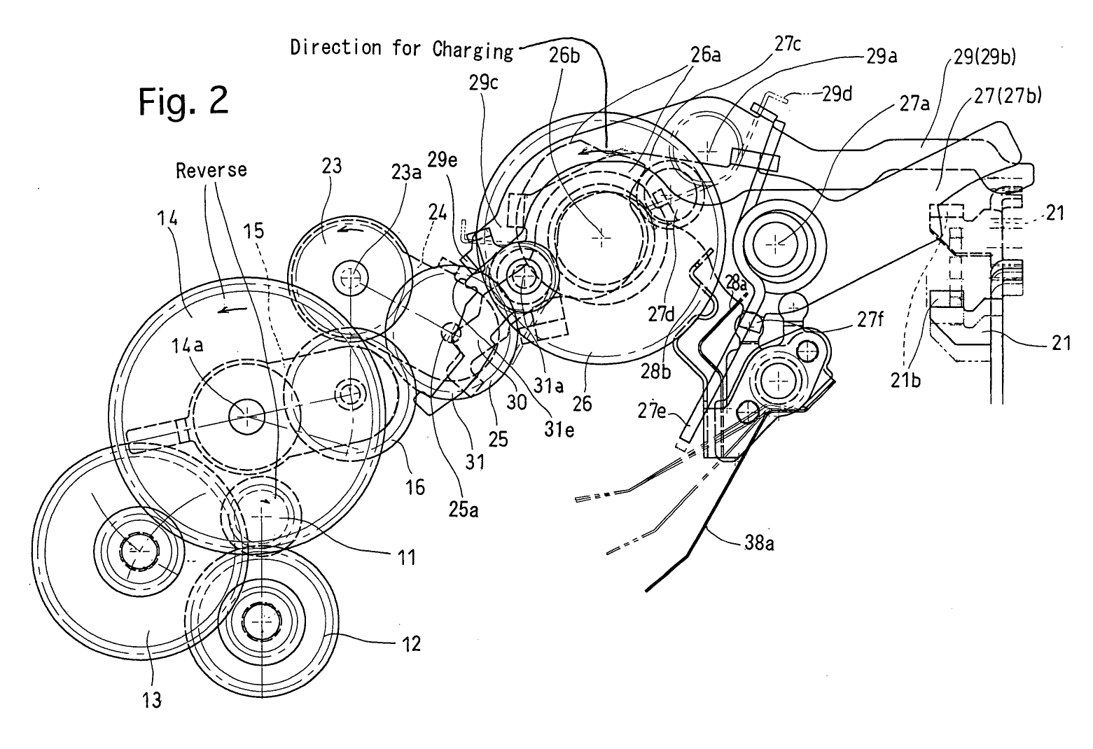

As shown in FIG. 2, the drive pinion 11 (motor 10) is driven reverse immediately after a lapse of a predetermined period of time (approximately a time Td3 as indicated in FIG. 8) from the completion of an exposure. This reverse rotation of the drive pinion 11 causes the first swingable lever 15 to rotate in the same direction (counterclockwise as viewed in FIG. 2) as that of the third double gear 14 so that the first planet gear 16, which is in mesh with the third double gear 14, is engaged with a fourth gear 23 serving as a sun gear of a second planetary gear mechanism. The second planetary gear mechanism consists of the fourth gear 23 serving as a sun gear, and a second planet gear 25 which is in mesh with the fourth gear 23. A second swingable lever 24 is pivoted at one end thereof about a rotational shaft 23a of the fourth gear 23. The second planet gear 25 is rotatably fitted on a pin 25a which is fixed at a free end of the second swingable lever 24 to extend parallel to the rotational shaft 23a. When the drive pinion 11 rotates reverse, the second planet gear 25 that is supported by the free end of the second swingable lever 24 is engaged with a cam-incorporated charge gear 26 which is rotatable at a fixed position about a rotational shaft 26b. A charge cam 26a is formed integral with the charge gear 26. The charge gear 26 rotates only counterclockwise as viewed in FIG. 2. The fourth gear 23, the second swingable lever 24, the second planet gear 25 and the cam-incorporated charge gear 26 constitute a mirror-shutter charge gear mechanism (charge mechanism) for the SLR camera driving system.

The SLR camera driving system is provided in the vicinity of the charge gear 26 with a charge lever 27. The charge lever 27 is pivoted about a rotational axis 27a extending parallel to the rotational shaft 26b. The charge lever 27 is provided with a first arm portion 27b and a second arm portion 27c. The charge lever 27 is provided at an approximate center of the second arm portion 27c with a follower roller 27d which is engaged with the charge cam 26a.

On the other hand, a free end of the first arm portion 27b extends up to a point to be engageable with the mirror charge lever 21. The charge lever 27 is biased to rotate counterclockwise as viewed in FIG. 2 (i.e., in a direction to make the first arm portion 27b move away from the mirror charge lever 21) by the spring force of a strong torsion spring (charge lever resetting spring) 27e so that the follower roller 27d is engaged with the charge cam 26a.

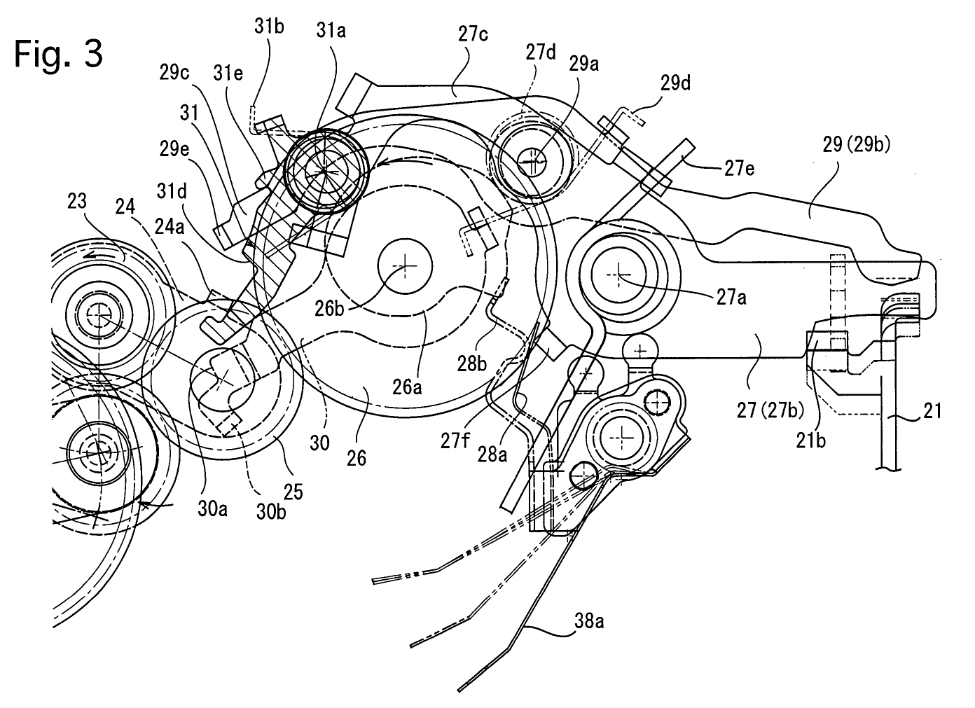

The reverse rotation of the drive pinion (motor 10) 11 performed after the completion of an exposure is transferred to the charge gear 26 via the first double gear 12, the second double gear 13, the third double gear 14, the first planet gear 16, the fourth gear 23 and the second planet gear 25, so that the charge gear 26 rotates counterclockwise as viewed in FIG. 2. The counterclockwise rotation of the charge gear 26 causes the charge cam 26a to press the follower roller 27d against the spring force of the torsion spring 27e to rotate the charge lever 27 clockwise as viewed in FIG. 2. This clockwise rotation of the charge lever 27 causes the first arm portion 27d thereof to rotate the mirror charge lever 21 in a direction to return the quick-return mirror 41 down to the viewing position, which in turn causes the stop arm portion 21b of the mirror charge lever 21 to be engaged with the engaging recess 20f so that the mirror charge lever 21 and the quick-return mirror 41 are positioned in their respective charge-completion positions (see FIG. 3). In this state, the extension spring 21a is expanded to store force (load) therein for raising the quick-return mirror 41 from the viewing position to the retracted position. In addition, when the mirror charge lever 21 rotates in a direction to return the quick-return mirror 41 down to the viewing position, the follower roller 21d of the mirror charge lever 21 presses the inner edge of the cam slot 42d of the shutter charge lever 42 to rotate the shutter charge lever 42 clockwise as viewed in FIGS. 7A and 7B. This clockwise rotation of the shutter charge lever 42 causes the second arm portion 42c thereof to press a shutter drive lever 43 to charge the shutter.

The SLR camera driving system is provided in the vicinity of the charge lever 27 with a mirror-down switch 28 having a first leaf 28a and a second leaf 28b. The charge lever 27 is provided in the vicinity of the rotational shaft 27a thereof with a pressing tab 27f for pressing the first leaf 28a. The pressing tab 27f presses the first leaf 28a to bring the first leaf 28a into contact with the second leaf 28b as shown in FIG. 3 to thereby detect that the quick-return mirror 41 is in the viewing position immediately before the charge lever 27 has been fully rotated clockwise as viewed in FIGS. 2 and 3 by the charge cam 26a when the charge lever 27 rotates in the same rotational direction.

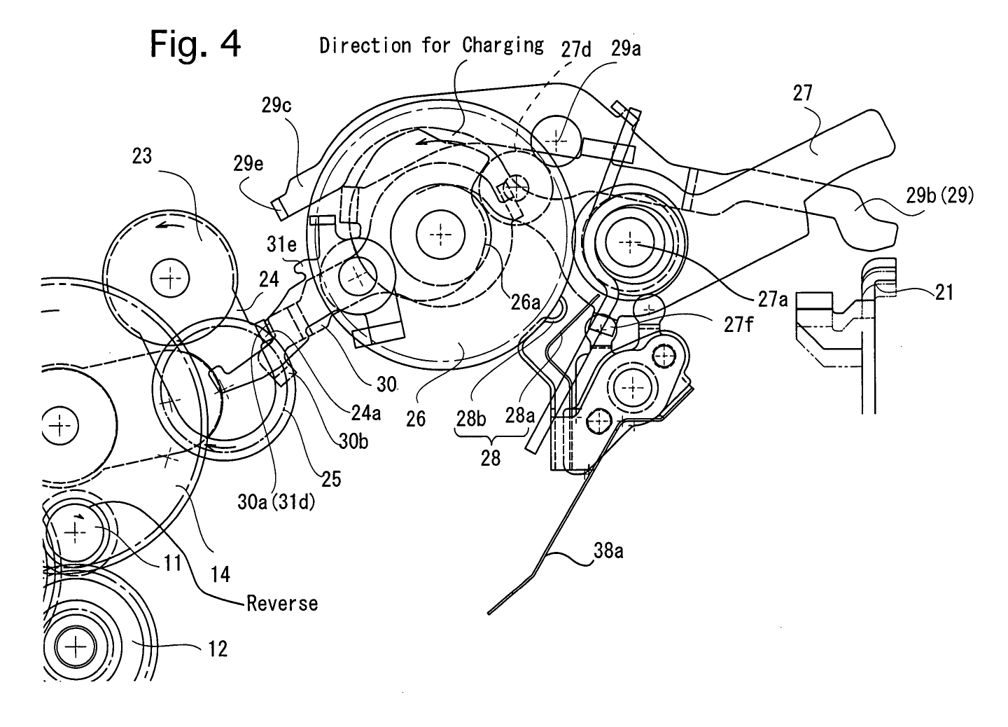

Even after the mirror-shutter charge operation is completed, the charge gear 26 continues to rotate counterclockwise (i.e., the drive pinion 11 (motor 10) is driven reversely) as viewed in FIG. 2 so that the charge lever 27 fully rotates clockwise and subsequently rotates counterclockwise as viewed in FIG. 2 and 3 by engagement of the charge cam 26a with the follower roller 27d. This causes the first leaf 28a to be disengaged from the second leaf 28b as shown in FIG. 4, i.e., causes a state of the mirror-down switch 28 to change from ON to OFF. A signal is issued upon the change of the mirror-up switch 22 from ON to OFF. Upon this signal being issued, the completion of the mirror-shutter charge operation is detected. In the case where no film is loaded in the camera, the motor 10 is stopped upon the detection of the completion of the mirror-shutter charge operation.

In the present embodiment of the SLR camera driving system, a film wind operation is performed by the aforementioned counterclockwise rotation of the charge gear 26 which continues even after the mirror charge operation is completed. The structure and operations of a film wind system (film advance system) of the SLR camera driving system will be hereinafter discussed with reference to FIGS. 2 through 4.

The SLR camera driving system is provided with a reset lever 29 which is pivoted about a rotational shaft 29a extending parallel to the rotational shaft 26b and being independent of the rotational shaft 26b of the charge gear 26 so that the reset lever 29 and the charge lever 27 partially overlap each other as viewed in FIGS. 2 through 4. The reset lever 29 is provided with first and second arm portions 29b and 29c extending in opposite directions away from each other from the rotational shaft 29a. A free end of the first arm portion 29b is positioned to face the mirror charge lever 21. The reset lever 29 is biased to rotate clockwise as viewed in FIGS. 2 through 4 in a direction to bring the free end of the first arm portion 29b into contact with the mirror charge lever 21 by the spring force of a torsion spring (reset lever resetting spring) 29d (see FIGS. 2 and 3), and the clockwise rotatable end of the reset lever 29 is restricted by a stop (not shown). Namely, the rotational position of the reset lever 29 depends upon the rotational position of the charge lever 21.

The SLR camera driving system is provided with a lock lever 30 which is pivoted about the rotational shaft 26b of the charge gear 26. The lock lever 30 is biased to rotate clockwise as viewed in FIGS. 2 through 4 by the spring force of the torsion spring 29d.

The SLR camera driving system is provided with a switch lever 31 pivoted about a rotational shaft 31a projecting from a free end of the second arm portion 27c, the rotational shaft 31a extending parallel to the rotational shaft 27a. In FIG. 3, the switch lever 31 is hatched for the purpose of clarity thereof. The switch lever 31 is biased to rotate clockwise as viewed in FIG. 3. The switch lever 31 abuts against an engaging tab 24a of the second swingable lever 24 when fully rotated clockwise. Namely, the clockwise rotatable end of the switch lever 31 is restricted by the engaging tab 24a of the second swingable lever 24.

To switch a motor drive system of the SLR driving system from a mirror-shutter charge system (mirror-shutter charge gear mechanism) of the SLR driving system to a film wind system (film-wind gear mechanism) of the SLR driving system by the aforementioned counterclockwise rotation of the charge gear 26 which continues rotating even after the mirror charge operation is completed, the charge lever 27, the reset lever 29, the lock lever 30 and the switch lever 31 are associated with each other in the following manner. Namely, the motor drive system is switched from the mirror-shutter charge system to the film wind system by moving the second swingable lever 24 from the position thereof shown in FIG. 3 to the position thereof shown in FIG. 4 and holding the second swingable lever 24 in the position shown in FIG. 4. In a state shown in FIG. 4, the second swingable lever 24 is locked with the engaging tab 24a of the second swingable lever 24 being engaged with a stop portion 30a of the lock lever 30 to prevent the second swingable lever 24 from rotating counterclockwise from the state shown in FIG. 4 to the state shown in FIG. 3. Namely, the motor drive system is prevented from being switched from the film wind system to the mirror-shutter charge system. The engaging tab 24a is bent at right angles to the plane of the second swingable lever 24.

As has been described above, the charge lever 27 rotates clockwise from the position shown in FIG. 2 to the position shown in FIG. 3 by counterclockwise rotation of the charge gear 26. Further counterclockwise rotation of the charge gear 26 in a state shown in FIG. 3 causes the charge lever 27 to rotate counterclockwise this time by engagement of the charge cam 26a with the follower roller 27d. This causes a pressing edge 31d of the switch lever 31, which is pivoted about the rotational shaft 31a projecting from the second arm portion 27c, to press the engaging tab 24a of the second swingable lever 24 to rotate the second swingable lever 24 clockwise from the state shown in FIG. 3 to the state shown in FIG. 4. When the second swingable lever 24 is rotated clockwise as shown in FIG. 4 by a movement of the lock lever 30, the stop portion 30a of the lock lever 30 is engaged with a stop (not shown) fixed to a camera body to stand by at a position where the stop portion 30a is engageable with the engaging tab 24a to hold the engaging tab 24a of the second swingable lever 24 rotating clockwise. In this state, the second swingable lever 24 is locked in a position (film-wind-system engaging position) to be engaged with the film wind system by both the lock lever 30 and the switch lever 31.

Operations of the SLR camera driving system upon a subsequent shutter release will be discussed hereinafter. As described above with reference to FIGS. 1 through 4, upon a shutter release signal (SWR shown in FIG. 8) being issued, the mirror charge lever 21 and the quick-return mirror 41 move to the respective retracted positions by the spring force of the extension spring 21a since the release lever 20 rotates counterclockwise as viewed in FIG. 1 to cause the stop arm portion 21b to be disengaged from the engaging recess 20f after a shutter release signal (SWR shown in FIG. 8) is issued. Such movement of the mirror charge lever 21 to the retracted position by the spring force of the extension spring 21a causes the mirror charge lever 21 to contact the first arm portion 29b of the reset lever 29, so that the reset lever 29 rotates counterclockwise as shown in FIG. 2. This causes an engaging tab 29e formed at one end (left end as viewed in FIGS. 2 through 4) of the reset lever 29 to contact a protrusion 31e of the switch lever 31 so that the switch lever 31 rotates counterclockwise as shown in FIG. 2. This counterclockwise rotation of the switch lever 31 causes the lock lever 30 to rotate in the same rotational direction via an engaging tab 30b of the lock lever 30 to unlock the second swingable lever 24.

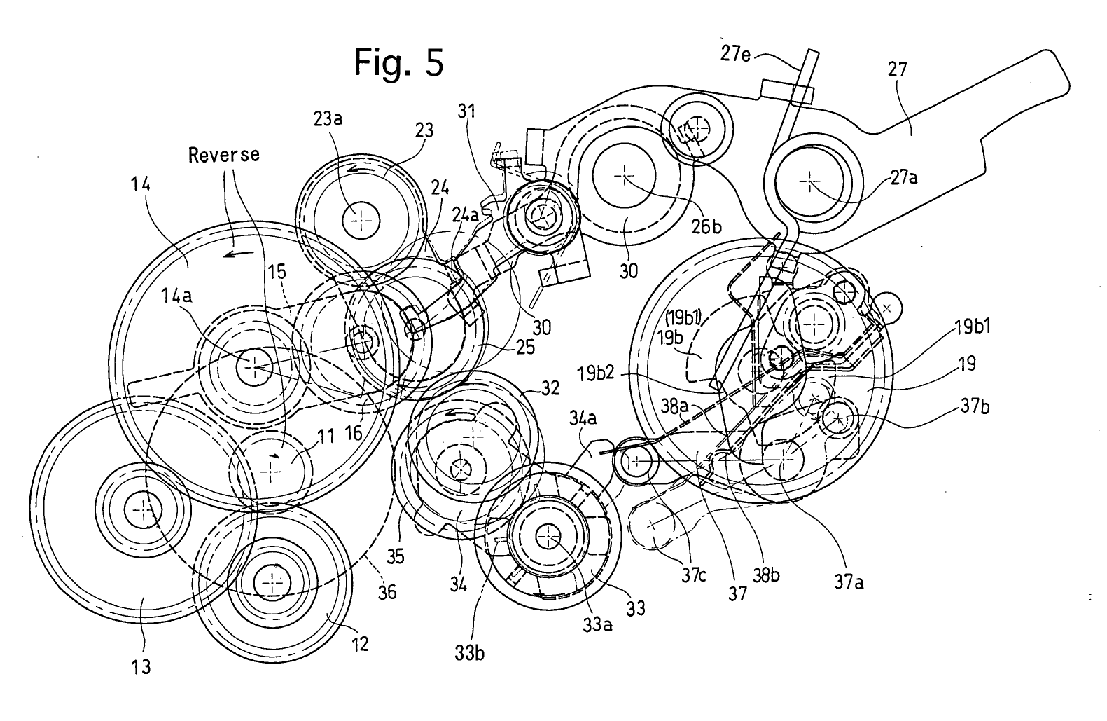

The structure and operations of the film wind system (film-wind gear mechanism) of the SLR camera driving system will be further discussed with reference to FIG. 5. The charge gear 26 is not shown in FIG. 5 for the purpose of clarity.

The SLR camera driving system is provided with a third planetary gear mechanism having a differential gear 33 serving as a sun gear, and a third planet gear 35 which is in mesh with the differential gear 33. A third swingable lever 34 is pivoted at one end thereof about a rotational shaft 33a of the differential gear 33. The third planet gear 35 is rotatably fitted on a pin which is fixed at a free end of the third swingable lever 34 to extend parallel to the rotational shaft 33a. When the second swingable lever 24 is locked in the aforementioned film-wind-system engaging position by both the lock lever 30 and the switch lever 31, the second planet gear 25 which is rotatably supported at the free end of the second swingable lever 24 is in mesh with an idle gear 32 to be connected with the differential gear 33. The third planet gear 35 is engaged with a film take-up spool 36. Accordingly, reverse rotation of the drive pinion 11 causes the film take-up spool 36 to rotate in a direction to wind up film if the film wind system is engaged with the motor drive system as shown in FIG. 5. The fourth gear 23, the second swingable lever 24, the second planet gear 25, the idle gear 32, the differential gear 33, the third swingable lever 34, the third planet gear 35 and the film take-up spool 36 constitute a film-wind gear mechanism of the SLR camera driving system.

However, the differential gear 33 rotates in a direction to cause the third swingable lever 34 (the third planet gear 35) move away from the film take-up spool 36. Accordingly, the SLR camera driving system is provided with a locking device for locking the third swingable lever 34 in a film wind position thereof. As described above with reference to FIG. 1, the release cam 19a and the lock cam 19b are formed on front and rear sides of the cam-incorporated gear 19, respectively. As shown in FIG. 5, the lock cam 19b controls the rotational position of a biasing lever 37 for film winding which is pivoted about a rotational shaft 37a. The biasing lever 37 is provided at a free end thereof with a roller 37c. The rotational shaft 37a is independent of the cam-incorporated gear 19. The lock cam 19b is symmetrical with respect to a rotational axis of the cam-incorporated gear 19, and is engaged with a follower roller 37b of the biasing lever 37. The lock cam 19b is composed of a pair of high cam edges 19b1 and a pair of low cam edges 19b2. In a state where the follower roller 37b is engaged with one of the pair of high cam edges 19b1, the roller 37c of the biasing lever 37 presses an engaging arm portion 34a of the third swingable member 34 to lock the third swingable member 34 in the film wind position. The cam-incorporated gear 19 has moved to the position thereof shown in FIG. 5 in a state before the shutter release signal is issued (initial state).

Accordingly, reverse rotation of the drive pinion 11 causes the film take-up spool 36 to rotate in a direction to wind up a film, and the motor 10 is turned OFF to stop rotating the drive pinion 11 immediately after a predetermined number of pulses corresponding to a single frame of film has been counted (see FIG. 8). This film wind operation is performed each time a release signal is issued, and is repeatedly performed until the final frame has been taken.

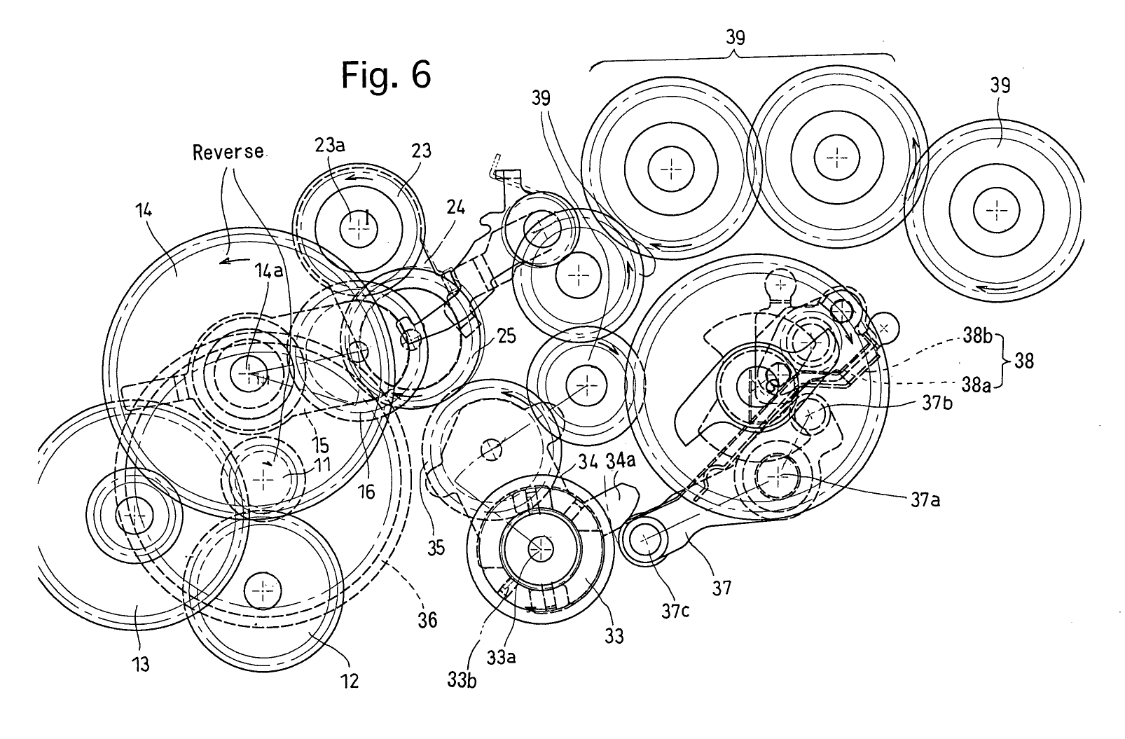

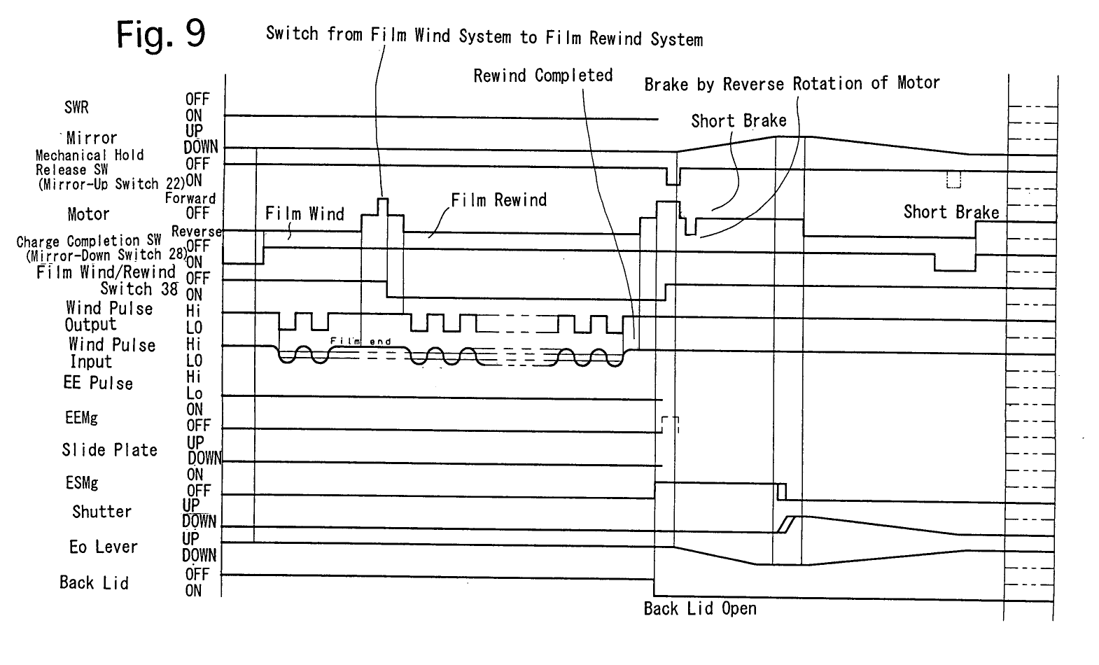

After the final frame has been taken, i.e., after film has been fully wound up around the film take-up spool 36, no more pulses (signals) indicating the motion of film are generated. If it is detected that no pulses are generated for a predetermined period of time, the drive pinion 11 (motor 10) is rotated forward slightly for a very small period of time and subsequently stopped rotating to switch the motor drive system from the film wind system to a film rewind system (film-rewind gear mechanism) (see FIG. 9). This slight forward rotation of the drive pinion 11 causes the roller 37c of the biasing lever 37 to be disengaged from the engaging arm portion 34a of the third swingable member 34 to unlock the third swingable member 34. Namely, the slight forward rotation of the drive pinion 11 causes the lock cam 19b of the cam-incorporated gear 19 to vary a point of engagement thereof with the follower roller 37b from one of the pair of high cam edges 19b1 to one of the pair of low cam edges 19b2. This causes the roller 37c to be disengaged from the engaging arm portion 34a, which in turn allows the third swingable lever 34 to be rotatable in a direction to disengage the third planet gear 35 from the film take-up spool 36 (see FIG. 6). As shown in FIG. 6, the SLR camera driving system is provided with a film wind/rewind switch 38 having a first leaf 38a and a second leaf 38b. When the biasing lever 37 rotates counterclockwise from the state shown in FIG. 5 by the forward rotation of the drive pinion 11, the first leaf 38a comes into contact with the second leaf 38b as shown in FIG. 6, to thereby detect that the motor drive system has been switched from the film wind system to the film rewind system. Upon this detection, the drive pinion 11 is driven reverse again (see FIG. 9).

When the drive pinion 11 is driven reverse again, the differential gear 33 is rotated clockwise as viewed in FIG. 6 so that the third swingable lever 34 has fully rotated clockwise in a direction away from the film take-up spool 36, the third planet gear 35 is engaged with an input gear of a film-rewind gear train 39. An output gear (final gear) of the film-rewind gear train 39 is engaged with a film rewind rotating fork (not shown) in the film cassette chamber so that film rewind operation is performed by reverse rotation of the drive pinion 11 (motor 10). Subsequently, when it is determined that no pulses indicating the motion of film are generated, the drive pinion 11 (motor 10) is stopped. The fourth gear 23, the second swingable lever 24, the second planet gear 25, the idle gear 32, the differential gear 33, the third swingable lever 34, the third planet gear 35 and the film-rewind gear train 39 constitute a film-rewind gear mechanism of the SLR camera driving system. Similar to the film-wind operation, the second planet gear 25 is prevented from being engaged with the cam-incorporated charge gear 26, via the engagement of the engaging tab 24a of the second swingable lever 24 and the stop portion 30a of the lock lever 30. Namely, the motor drive system is prevented from being switched from the film rewind system to the mirror-shutter charge system.

The differential gear 33 is composed of a pair of coaxial gears having the same shape and size which are rotatable relative to each other about the common rotational shaft 33a of the differential gear 33 within a predetermined angle of rotation. The pair of coaxial gears are biased to rotate in opposite rotational directions by the spring force of a torsion spring 33b.

As described above, the second planet gear 25 is forcefully brought into engagement with the idle gear 32, which serves as a gear of the film wind system, by a counterclockwise rotation of the charge lever 27 by the spring force of the torsion spring 27e immediately after the above described operation of the mirror-shutter charge system by rotation of the second planet gear 25 is completed. During this operation, the film wind system applies a load to the second planet gear 25 to prevent the second plant gear 25 from being engaged with the idle gear 32 of the film wind system at the moment the second planet gear 25 starts to engage with the idle gear 32. If the restoring force of the charge lever 27 by the spring force of the torsion spring 27e is greater than such a load which is applied to the second planet gear 25 by the film wind system, the second planet gear 25 will be securely engaged with idle gear 32 against the action on the second planet gear 25. However, giving such a large restoring force to the charge lever 27 is impractical. Accordingly, besides the restoring force to the charge lever 27, the present embodiment of the SLR camera driving system is provided with a special locking device which locks the second planet gear 25 upon completion of engagement of the second planet gear 25 with the idle gear 32 that serves as a gear of the film wind system. The third swingable lever 34, the lock cam 19b and the biasing lever 37 are fundamental elements of the special locking device. In addition, the present embodiment of the SLR camera driving system is provided with the differential gear 33 to prevent load from being directly applied to the charge lever 27 by the film wind system during the time from the moment the second plant gear 25 starts being engaged with the idle gear 32 of the film wind system to the moment the second planet gear 25 is locked completely by the special locking device. The differential gear 33 relieves the aforementioned load by slipping between the pair of coaxial gears of the differential gear 33.

As can be understood from the foregoing, according to the present invention, a method and system for driving an SLR camera with a single motor are achieved, wherein a mirror release operation in which a quick-return mirror rises upon a shutter release is performed by a forward rotation of the motor, a film wind operation is performed by a reverse rotation of the motor, a film rewind operation is performed by a reverse rotation of the motor, and a mirror-shutter charge operation is performed by a reverse rotation of the motor.

Obvious changes may be made in the specific embodiment of the present invention described herein, such modifications being within the spirit and scope of the invention claimed. It is indicated that all matter contained herein is illustrative and does not limit the scope of the present invention.

What is claimed is:

1. A method of driving an SLR camera, having a film, using a single motor to perform a film wind operation, a film rewind operation, a mirror-shutter charge operation, and a mirror release operation in which a quick-return mirror rises upon a shutter release, said method comprising:
driving said motor forward to perform said mirror release operation upon a detection of said shutter release;
driving said motor in reverse to firstly switch a motor drive system including said motor to a mirror-shutter charge system upon detecting a signal indicating that an operation of a shutter is completed, and subsequently performing said mirror-shutter charge operation;
driving said motor to continue rotating in reverse to switch said motor drive system from said mirror-shutter charge system to a film wind system even after said quick-return mirror returns to a viewing position by said mirror-shutter charge operation;
driving said motor to continue rotating in reverse to perform said film wind operation;
driving said motor forward for a predetermined period of time to switch said motor drive system from said film wind system to a film rewind system upon detecting a signal indicating that no more frames of said film are available; and
driving said motor in reverse to perform said film rewind operation.

2. The method of driving the SLR camera according to claim 1, wherein said method further comprises:
putting said motor drive system into a state where said motor drive system is prevented from switching to said mirror-shutter charge system when said film wind operation and film rewind operation are performed; and
putting said motor drive system into a state where said motor drive system is allowed to switch to said mirror-shutter charge system in conjunction with a rising motion of said quick-return mirror upon said mirror release operation.

3. A driving system for an SLR camera, having a film, using a single motor to perform a film wind operation, a film rewind operation, a mirror-shutter charge operation, and a mirror release operation in which a quick-return mirror rises upon a shutter release, said driving system comprising:
a release device which drives said motor forward to perform said mirror release operation upon a detection of said shutter release;
a switch/charge device which is actuated upon said motor being driven in reverse to firstly switch a motor drive system including said motor to a mirror-shutter charge system upon detecting a signal indicating that an operation of a shutter is completed, and subsequently perform said mirror-shutter charge operation;
a first switch device which drives said motor to continue rotating reverse to switch said motor drive system from said mirror-shutter charge system to a film wind system even after said quick-return mirror returns to a viewing position by said mirror-shutter charge operation;
a film wind device which drives said motor to continue rotating reverse to perform said film wind operation;
a second switch device which drives said motor forward for a predetermined period of time to switch said motor drive system from said film wind system to a film rewind system upon detecting a signal indicating that no more film frame is available; and
a film rewind device which drives said motor reverse to perform said film rewind operation.

4. The driving system for the SLR camera according to claim 3, further comprising:
a locking device which puts said motor drive system into a state where said motor drive system is prevented from switching to said mirror-shutter charge system when said film wind operation and film rewind operation are performed; and
an unlocking device which puts said motor drive system into a state where said motor drive system is allowed to switch to said mirror-shutter charge system in conjunction with a rising motion of said quick-return mirror upon said mirror release operation.

5. An SLR camera using a single motor to perform a film wind operation, a film rewind operation, a mirror-shutter charge operation, and a mirror release operation in which a quick-return mirror rises upon a shutter release, said SLR camera comprising:
a film-wind gear mechanism used for said film wind operation;
a film-rewind gear mechanism used for said film rewind operation;
a mirror-shutter charge gear mechanism used for said mirror release operation;
a mirror release gear mechanism used for said mirror release operation;
a motor drive gear mechanism which is selectively engaged with said film wind gear mechanism, said film rewind gear mechanism, said mirror-shutter charge gear mechanism and said mirror release gear mechanism; and
a motor controller for controlling operation of said motor,
wherein said motor controller drives said motor forward to bring said motor drive gear mechanism into engagement with said mirror release gear mechanism to perform said mirror release operation upon a detection of said shutter release, a rising motion of said quick-return mirror making it possible to bring said motor drive gear mechanism into engagement with said mirror-shutter charge gear mechanism;
wherein said motor controller drives said motor in reverse to firstly bring said motor drive gear mechanism into engagement with said mirror-shutter charge gear mechanism upon detecting a signal indicating that an operation of a shutter is completed, and subsequently perform said mirror-shutter charge operation;
wherein said motor controller drives said motor to continue rotating in reverse to bring said motor drive gear mechanism into engagement with said film wind gear mechanism even after said quick-return mirror returns to a viewing position by said mirror-shutter charge operation;
wherein said motor controller drives said motor to continue rotating in reverse to perform said film wind operation;
wherein said motor controller drives said motor forward for a predetermined period of time to bring said motor drive gear mechanism into engagement with said film rewind gear mechanism upon detecting a signal indicating that no more film frame is available; and
wherein said motor controller drives said motor reverse to perform said film rewind operation.

6. A driving system for an SLR camera comprising:
a motor;
a release mechanism which performs a mirror-shutter release operation in which a quick-return mirror is removed from a viewing position, on a photographing path, to raised position, out of said photographing path, and a mechanical stopper for a shutter is released;
a charge mechanism which performs a mirror-shutter charge operation in which said quick-return mirror is returned to said viewing position and said shutter is charged;
a film-wind mechanism which performs a film wind operation;
a film rewind mechanism which performs a film rewind operation; and
a switching device provided between said motor and said release mechanism, said charge mechanism, said film-wind mechanism, and said film rewind mechanism, wherein said mirror-shutter release operation is performed by said release mechanism when said motor drives forward; and wherein said mirror-shutter charge operation, said film wind operation and said film rewind operation are performed by said charge mechanism, said film wind mechanism and said film rewind mechanism, respectively, when said motor drives in reverse after said release operation is completed.
